(19) United States
(12) Patent Application Publication
(10) Pub. No.: US 2026/0012488 A1
(43) Pub. Date: Jan. 8, 2026

(54) NEAR REAL TIME AGGREGATION USING DYNAMIC DATA EXTRACTION

(71) Applicant: Cequence Security, Inc., Sunnyvale, CA (US)

(72) Inventors: Nikunj Bansal, Cupertino, CA (US); Stephen Leigh James, Cincinnati, OH (US)

(21) Appl. No.: 18/968,177

(22) Filed: Dec. 4, 2024

Related U.S. Application Data
(60) Provisional application No. 63/667,934, filed on Jul. 5, 2024.

(51) Int. Cl. H04L 9/40

(52) U.S. Cl. CPC H04L 63/20

(57) ABSTRACT

Various embodiments include a system to aggregate transactions logged by a distributed streaming platform. The system comprises processing circuitry. The processing circuitry obtains an identifier that indicates a data item associated with an API infrastructure. The processing circuitry processes the transactions of the API infrastructure logged by the distributed streaming platform to extract a named property from the transactions based on the identifier. The processing circuitry generates a data aggregation key based on the extracted named property. The processing circuitry aggregates the transactions based on the data aggregation key. The processing circuitry provides aggregation data that characterizes the aggregated transactions to a security policy generation system.

### TECHNICAL FIELD

This U.S. Patent Application claims the benefit of and priority to U.S. Provisional Patent Application 63/667,934 titled, “NEAR REAL TIME AGGREGATION USING DYNAMIC DATA EXTRACTION” which was filed on Jul. 5, 2024, and which is hereby incorporated by reference into this U.S. Patent Application in its entirety.

### TECHNICAL FIELD

Various embodiments of the present technology relate to Application Programming Interface (API) Security, and more specifically, to dynamically aggregating transactions logged by a distributed streaming platform.

### BACKGROUND

The security of a web service is of upmost importance to both the operators of the website and its users. As Internet communications expand for business transactions and other services, more threats to website security arise. Website owners, insurers, hosting services, and others involved in the provision of a web service typically strive to create a robust security infrastructure for a website to prevent nefarious individuals from compromising the site. However, despite these security precautions, a website could still be subject to intrusions by computer hackers, malware, viruses, and other malicious attacks. Websites may be vulnerable to security breaches for a variety of reasons, including security loopholes, direct attacks by malicious individuals or software applications, dependencies on compromised third-party providers, and other security threats. Security systems are employed by websites to counteract the wide range of threats.

Many web applications utilize Application Programming Interfaces (APIs) based applications for functions like sales productivity, collaboration, marketing automation, and project tracking. API usage has increased as organizations have expanded their use of microservices and created new cloud-native applications. The consumer facing applications that the organizations create are often API based. This API ecosystem is fueled by increases in public cloud environments, Kubernetes environments, serverless environments, and use of third-party Software As A Service (SaaS) systems. Developers may roll out new API driven services in any environment. Critical information like personal information, financial information, health information, and the like is stored behind the applications that host these APIs. Malicious actors often utilize APIs as entry points to perform unwanted actions (e.g., obtaining sensitive data).

To counteract the malicious use of APIs, API ecosystems employ API security systems to track inputs and outputs to APIs. The API security systems block unauthorized requests to the APIs and unauthorized responses generated by the APIs to inhibit unwanted API behaviors like sensitive data exposure. API ecosystems may comprise large numbers of APIs which handle a correspondingly large volume of API traffic. Due to the large number of APIs and high traffic volume, some API security systems utilize distributed streaming platforms to track traffic through the API infrastructures. Distributed streaming platforms record API transactions (e.g., API requests, API responses, etc.) as a time ordered series of events thereby allowing the API security systems to understand the flow of data through the API ecosystems over time.

Unfortunately, API security systems do not efficiently leverage their distributed streaming platforms to inhibit unwanted API behavior. Moreover, API security systems do not effectively aggregate and track API behavior logged by distributed streaming platforms based on user defined parameters.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for Application Programming Interfaces (APIs). Some embodiments comprise a method to aggregate transactions logged by a distributed streaming platform. The method comprises obtaining an identifier that indicates a data item associated with an Application Programming Interface (API) infrastructure. The method further comprises processing the transactions of the API infrastructure logged by the distributed streaming platform to extract a named property from the transactions based on the identifier. The method further comprises generating a data aggregation key based on the extracted named property. The method further comprises aggregating the transactions based on the data aggregation key. The method further comprises providing aggregation data that characterizes the aggregated transactions to a security policy generation system.

Some embodiments comprise a system to aggregate transactions logged by a distributed streaming platform. The system comprises processing circuitry. The processing circuitry obtains an identifier that indicates a data item associated with an API infrastructure. The processing circuitry processes the transactions of the API infrastructure logged by the distributed streaming platform to extract a named property from the transactions based on the identifier. The processing circuitry generates a data aggregation key based on the extracted named property. The processing circuitry aggregates the transactions based on the data aggregation key. The processing circuitry provides aggregation data that characterizes the aggregated transactions to a security policy generation system.

Some embodiments comprise one of more non-transitory computer readable storage media having program instructions stored thereon to aggregate transactions logged by a distributed streaming platform. When executed by a computing system, the program instructions direct the computing system to perform operations. The operations comprise obtaining an identifier that indicates a data item associated with an API infrastructure. The operations further comprise processing the transactions of the API infrastructure logged by the distributed streaming platform to extract a named property from the transactions based on the identifier. The operations further comprise generating a data aggregation key based on the extracted named property. The operations further comprise aggregating the transactions based on the data aggregation key. The operations further comprise providing aggregation data that characterizes the aggregated transactions to a security policy generation system.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an exemplary system to perform near real time data aggregation and extraction.

FIG. 2 illustrates an exemplary operation of the system to perform near real time data aggregation and extraction.

FIG. 3 illustrates another exemplary operation of the system to perform near real time data aggregation and extraction.

FIG. 4 illustrates another exemplary system to perform near real time data aggregation and extraction.

FIG. 5 illustrates an exemplary key extraction process for near real time data aggregation and extraction.

FIG. 6 illustrates an exemplary distributed streaming platform for near real time data aggregation and extraction.

FIG. 7 illustrates a first exemplary user interface for near real time data aggregation and extraction.

FIG. 8 illustrates a second exemplary user interface for near real time data aggregation and extraction.

FIG. 9 illustrates a third exemplary user interface for near real time data aggregation and extraction.

FIG. 10 illustrates a fourth exemplary user interface for near real time data aggregation and extraction.

FIG. 11 illustrates a fifth exemplary user interface for near real time data aggregation and extraction.

FIG. 12 illustrates a sixth exemplary user interface for near real time data aggregation and extraction.

FIG. 13 illustrates a seventh exemplary user interface for near real time data aggregation and extraction.

FIG. 14 illustrates an eighth exemplary user interface for near real time data aggregation and extraction.

FIG. 15 illustrates an exemplary computing system for near real time data aggregation and extraction.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Historically, automated attacks against APIs have focused on the protocol and transport layer where a malicious actor will attempt to compromise a system by targeting vulnerabilities in the platform and architecture. Protection against these types of attacks is based on adopting best practices, modern frameworks and appliances, and robust monitoring. Some attacks focus on exploiting the intended sequence of interactions of online applications. The behavior employed by an attacker may be to attempt to assume another user's identity, or to gain access to a restricted API with unintended credentials. Some attacks are focused on the abuse of an application business logic. Attackers learn the nuance of internet-facing APIs, and attempt to use APIs in unintended ways. For example, an attacker might attempt to change user IDs or card numbers in a payment processing payload. Attacks are increasingly difficult to detect when APIs are accessed legitimately. Prevention of such attacks is rooted in server-side validation of all data received from the public using the APIs. However, vulnerable APIs have a sever cost to organizations, particularly those with payment or gift card systems.

Attackers often start with exploration and discovery of the attack surface of APIs. Attacks may become increasingly complex as they gain knowledge about the APIs. While API developers may be vigilant, the fact remains that it is difficult to predict how attackers may use APIs in ways that they were not intended to be used. In a sense, attackers may move beyond technical and behavioral vulnerabilities and abuse the business logic of APIs to gain their advantage. Most security and monitoring systems collect aggregations on well-known pieces of internet traffic, such as host names, Uniform Resource Indicators (URIs), headers, and body fields. However, most conventional platforms do not allow the collection of aggregations based on customer-specific and business critical data elements. In the example of a banking customer, the ability to collect aggregations by account number or branch number are critical capabilities to detecting business logic abuse using those attributes.

Real-time streaming has exploded in popularity with platforms such as Apache Spark, Flink, and Kafka Streams. These data streaming platforms bring the capability of real time aggregations of transactions. However, typically a topology (or flow of data) through the distributed streaming platform must be well defined before events are processed by the system. This means that aggregation keys and topics must be defined from configuration of discrete data elements that are known to be available during the development process. Various embodiments of the present technology allow for the creation of unique aggregation keys at any time through a custom, purpose-built user interface. There is no requirement to configure or modify systems or topology to enable new aggregations in real time. Once aggregation keys are defined by a user, the computing systems disclosed herein begin processing the aggregation according to its defined configuration.

A transaction is a request and response captured by the API Gateway and is used as input into the streaming analysis pipeline. A data extraction is a named property that has been extracted from the request and/or response (i.e., transaction). Extractions can either be the value of named fields such as those located in the headers or body. They can also be the results of more complex scripts with conditional logic and/or dynamic responses. An aggregation key comprises a custom key composed of one or many named data extractions. A unique value aggregation comprises a rolling count of unique values grouped by aggregation key. For example, a unique value aggregation may comprise the count of unique Internet Protocol (IP) addresses by host name. The unique value can be from well-known properties of Hypertext Transport Protocol (HTTP), or can be the result of a data extraction. A condition aggregation comprises a rolling count of custom rule conditions grouped by aggregation key. For example, a condition aggregation may comprise the count of unauthenticated requests by URI. A statistical aggregation comprises a rolling transaction count grouped by aggregation key. For example, a statistical aggregation may comprise the count of a particular data item or condition per an IP address.

Various embodiments of the present technology allow for the creation of custom data extractions which allows a customer to define unique pieces of data that are most important to business flow. The named extractions can be dynamic where they can match a host and path, and dynamically extract from various locations in the request/response payload. For example, a banking customer may choose to extract account number, or a telecom customer may choose to extract International Mobile Equipment Identity (IMEI) and/or Subscriber Identity Module (SIM) numbers. The customer may choose whether the extraction should be used as an aggregation key. When defining an aggregation key, the user can choose which types of aggregations should apply to the key. Given the example of IMEI in telecom, a user of the system may choose to count the unique IP address or unique session identifiers per IMEI key. Thus, the user is able to define keys and aggregations that are relevant to their line of business. They move beyond well-known protocol level data attributes, and are able to track behavioral attributes that an attacker is using to uniquely attack their business logic. Now referring to the Figures.

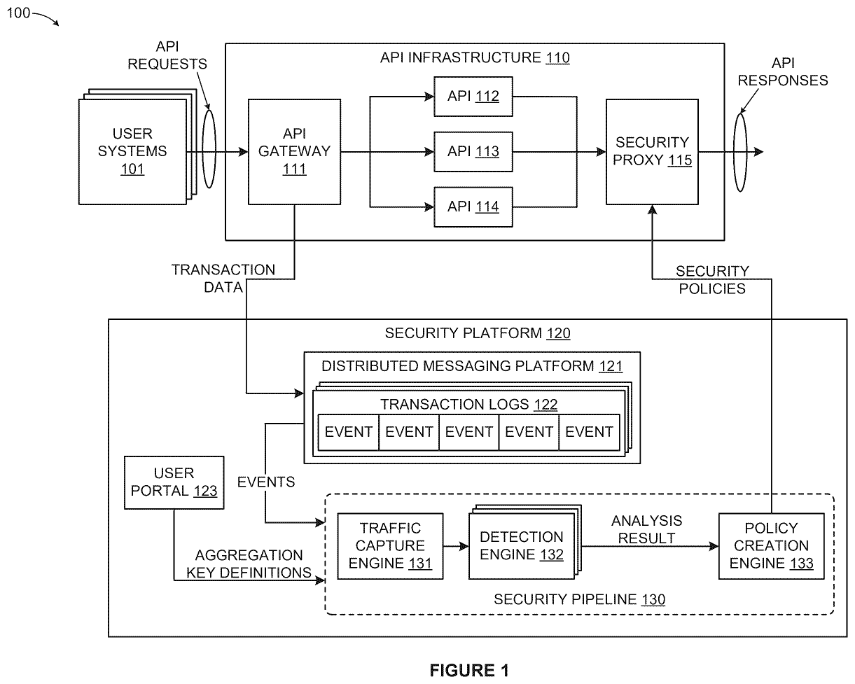

FIG. 1 illustrates system 100 to aggregate transactions logged by a distributed streaming platform. System 100 provides services like online networking, content distribution, web application services, web application security, machine learning, data logging, data aggregation, and the like. System 100 comprises user systems 101, API infrastructure 110, and security platform 120. Infrastructure 110 comprises API gateway 111, APIs 112-114, and security proxy 115. Security platform 120 comprises distributed messaging platform 121, user portal 123, and security pipeline 130. Distributed messaging platform 121 comprises transaction logs 122. Security pipeline 130 comprises traffic capture engine 131, detection engine 132, and policy creation engine 133. In other examples, system 100 may comprise additional or different elements than those illustrated in FIG. 1. Likewise, the illustrated components of system 100 may include fewer or additional components, assets, or connections than shown. User systems 101, API infrastructure 110, and security platform 120 may be representative of a single computing apparatus or multiple computing apparatuses.

Various examples of network operation and configuration are described herein. In some examples, API infrastructure 110 is representative of an enterprise computing environment that comprises a processing system and communication transceiver. API infrastructure 110 may also include other components like a user interface, data storage system, and power supply. Examples of API infrastructure 110 may include server computers and data storage devices deployed on-premises, in the cloud, in a hybrid cloud, or elsewhere, by service providers such as enterprises, organizations, individuals, and the like. API infrastructure 110 may rely on the physical connections provided by one or more other network providers such as transit network providers, Internet backbone providers, and the like to communicate with and provide services 114 to external systems. In some examples, the computing systems of API infrastructure 110 could comprise a web server, CDN, forward/reverse proxy, load balancer, middleware, cloud server, network switch, router, switching system, packet gateway, network gateway system, Internet access node, application server, database system, service node, firewall, or some other communication system, including combinations thereof. The computing system of API infrastructure 110 may reside in a single device or may be distributed across multiple devices and may be a discrete system or could be integrated within other systems, including other systems within system 100.

Gateway 111 is a computing system that comprises a processing system and communication transceiver. Gateway 111 routes the API calls to ones of APIs 112-114 in infrastructure 110. Gateway 111 copies the API transactions (e.g., API requests and corresponding API responses) to distributed messaging platform 121. For example, gateway 111 may receive API calls from user systems 101 like mobile computing devices, such as cell phones, tablet computers, laptop computers, notebook computers, and gaming devices, as well as any other type of mobile computing devices and any combination or variation thereof. User systems 101 are computing systems that comprise a processing system and communication transceiver. Other exemplary user systems include desktop computers, server computers, and virtual machines, as well as any other type of computing system, variation, or combination thereof. User systems 101 may comprise human controlled systems (e.g., a smartphone) or automated systems (e.g., a bot). The computing systems of user systems 101 may reside in a single device or may be distributed across multiple devices and may be a discrete system or could be integrated within other systems, including other systems within system 100.

Gateway 111 may include components like a user interface, data storage system, and power supply. Examples of gateway 111 include Content Deliver Network (CDN) gateways, API gateways, default gateways, media gateways, payment gateways, Voice Over Internet Protocol (VoIP) gateways, residential gateways, enterprise gateways, cloud gateways, IoT gateways, as well as any other type of gateway computing devices and any combination or variation thereof. Examples of gateway 111 also include desktop computers, server computers, and virtual machines, as well as any other type of computing system, variation, or combination thereof. The computing system of gateway 111 may reside in a single device or may be distributed across multiple devices and may be a discrete system or could be integrated within other systems, including other systems within system 100.

APIs 112-114 are representative of a set of API servers, computing systems, and/or network equipment configured to provide services and web resources to clients and/or operators of infrastructure 110. In particular, APIs 112-114 process requests received over gateway 111 and generate responses based on their functionality and the request. APIs 112-114 may comprise client-side APIs and server-side APIs. APIs 112-114 may be representative of any computing apparatus, system, or systems that may connect to another computing system over a communication network. APIs 112-114 comprise a processing system and communication transceiver. APIs 112-114 may also include other components such as routers, data storage systems, and power supplies. APIs 112-114 may reside in a single device or may be distributed across multiple devices. APIs 112-114 may comprise discrete systems or may be integrated within other systems, including other systems within system 100. Some examples of computing systems that host APIs 112-114 include database systems, server computers, cloud computing platforms, and virtual machines, as well as any other type of computing system, variation, or combination thereof. The API servers can be in various environments like the cloud, Kubernetes, serverless, data center, and the like.

APIs 112-114 are vulnerable to a variety of security threats. In particular, malicious actors may transfer API calls to attempt to drive APIs 112-114 to behave in an unwanted manner. Exemplary security vulnerabilities include sensitive data leakage, prompt injection attacks, data poisoning, insecure output handling, denial of service, permission issues, excessive agency, insecure plugins, and the like. For example, a malicious actor may transfer a malicious API call to API 112 to drive API 112 to expose sensitive information like credit card numbers or social security numbers in their outputs resulting in sensitive data leaks. This includes personal identifiable information (PII), financial details, health records, and confidential business information, leading to breaches of privacy and compliance violations. As such, security platform 120 is utilized to aggregate transactions executed by APIs 112-114 to detect malicious activity, develop security policies based on the detected activity, and enforce the policies to mitigate the malicious activity.

Security proxy 115 is representative of servers, computing systems, and/or network equipment to enforce security policies on API calls/responses received and transferred by API infrastructure 110. The security policies block malicious or otherwise unwanted API calls from being propagated through infrastructure 110. Proxy 115 comprises a processing system and communication transceiver. Proxy 115 may also include other components such as routers, data storage systems, and power supplies. Proxy 115 may reside in a single device or may be distributed across multiple devices. Proxy 115 may comprise discrete systems or may be integrated within other systems, including other systems within system 100. Some examples of computing systems that host proxies 115 include database systems, server computers, cloud computing platforms, and virtual machines, as well as any other type of computing system, variation, or combination thereof.

Security platform 120 is representative of an API infrastructure security platform to aggregate transactions between APIs based on aggregation key derived from extracted data items from the transactions and generate security policies for API infrastructure 110 based on the aggregated transactions. Security platform 120 captures the API requests and responses for APIs 112-114 via API gateway 111 and logs the transactions in distributed messaging platform 121. By logging the transactions in distributed messaging platform 121, security platform 120 may aggregate transactions of API infrastructure 110 in real or near-real time thereby facilitating the creation and implementation of security policies. The security policies mitigate anomalous or otherwise unwanted behavior of APIs 112-114 indicated by the aggregated transactions.

Security platform 120 may comprise servers, cloud computing systems, hybrid-cloud computing systems, virtualized computing infrastructures, and/or any other computing system, network equipment, apparatus, system, or systems that may connect to another computing system over a communication network. Security platform 120 comprises processing systems and communication transceivers. Security platform 120 maintains distributed messaging platform 121, provides user portal 123, and hosts security pipeline 130. Security platform 120 may also include other components such as a router, server, data storage system, and power supply. Security platform 120 may reside in a single device or may be distributed across multiple devices. Security platform 120 may be a discrete system or may be integrated within other systems, including other systems within system 100. Some examples of Security platform 120 include database systems, desktop computers, server computers, cloud computing platforms, and virtual machines, as well as any other type of computing system, variation, or combination thereof.

Distributed messaging platform 121 maintains transactions logs 122. Distributed messaging platform 121 records transactions received from API gateway 111 in logs 122. The transactions stored in logs 122 are time ordered into events. As such, logs 122 describe the operations of APIs 112-114 over time. Logs 122 record the transactions of APIs 112-114 redundantly (e.g., a first one of logs 122 and a second one of logs 122 record the same transactions) to increase the immutability and scalability of distributed messaging platform 121. Exemplary distributed streaming platform types include Apache Kafka, Apache Flink, and Apache Spark.

User portal 123 comprises a user interface system that allows users associated with API infrastructure 110 to select aggregation key definitions. An aggregation key definition includes a set of parameters that inform security platform 120 on how to aggregate transactions obtained via API gateway 111. Exemplary user interface systems include user computers, mobile computing devices, tablet computers, and the like. The user interface of portal 123 may comprise a web portal or similar application to facilitate communication between the user and security platform 120. In some examples, user portal 123 is omitted and the aggregation key definitions may be autonomously defined (e.g., using machine leaning techniques).

Security pipeline 130 is representative of a set of computing modules to ingest events recording by distributed messaging platform 121, extract data from the events based on the aggregation key definitions, generate aggregation keys that comprise the extractions, aggregate transactions based on the aggregation keys, and generate security polices based on the resulting aggregations. Pipeline 130 comprises traffic capture engine 131, detection engine 132, and policy creation engine 133. Traffic capture engine 131 comprises capabilities for streaming platform interfacing, event retrieval, event pre-processing, and the like. Detection engine 132 is representative of a distributed platform with capabilities for aggregation key definition handling, event data extraction, event value extraction, aggregation key generation, event aggregation, event value aggregation, and event aggregation analysis. Detection engine 132 performs data extractions based on user defined aggregation key definitions and generate aggregation keys using the extracted data. Detection engine 132 may comprise multiple nodes, multiple copies, and/or implement some other distribution technique. Each node of detection engine 132 may store a state representing some aspect of transaction logs 122 to increase the immutability and scalability of detection engine 132. Policy creation engine 133 comprises capabilities for security policy generation and security policy enforcement. Pipeline 130 may include other modules (omitted from FIG. 1 for clarity) with additional functionality. Engines 131-133 may be representative of artificial intelligence and/or machine learning models (e.g., Large Language Models (LLMs), neural networks, time series models, etc.).

User systems 101, gateway 111, infrastructure 110, and security platform 120 communicate over communication systems like routers, gateways, telecommunication switches, servers, processing systems, or other communication equipment and systems for providing communication and data services. The communication systems could comprise wireless communication nodes, telephony switches, Internet routers, network gateways, computer systems, communication links, or some other type of communication equipment, including combinations thereof. The communication systems may also comprise optical networks, packet networks, local area networks (LAN), metropolitan area networks (MAN), wide area networks (WAN), or other network topologies, equipment, or systems, including combinations thereof. Gateway 111, infrastructure 110, and security platform 120 may communicate over wired or wireless communication links. The communication systems may use Internet Protocol (IP), Institute of Electrical and Electron Engineers (IEEE) 802.11 (Wifi), IEEE 802.3 (Ethernet), optical networking, wireless protocols, communication signaling, or some other communication format, including combinations thereof.

User systems 101, gateway 111, infrastructure 110, and security platform 120 comprise microprocessors, software, memories, transceivers, bus circuitry, and the like. The microprocessors comprise Central Processing Units (CPU), Graphical Processing Units (GPU), Application-Specific Integrated Circuits (ASIC), Field Programmable Gate Array (FPGA), and/or types of processing circuitry. The memories comprise Random Access Memory (RAM), Solid State Drives (SSDs), Hard Disk Drives (HDDs), Non-Volatile Memory Express (NVMe) SSDs, and/or the like. The memories store software like operating systems, security modules, machine learning models, user applications, web applications, and browser applications. The microprocessors retrieve the software from the memories and execute the software to drive the operation of system 100 as described herein. The communication links that connect the elements of system 100 use metallic links, glass fibers, radio channels, or some other communication media. The communication links use ENET, Time Division Multiplex (TDM), Data Over Cable System Interface Specification (DOCSIS), Internet Protocol (IP), General Packet Radio Service Transfer Protocol (GTP), WiFi, Ethernet, virtual switching, inter-processor communication, bus interfaces, and/or some other data communication protocols.

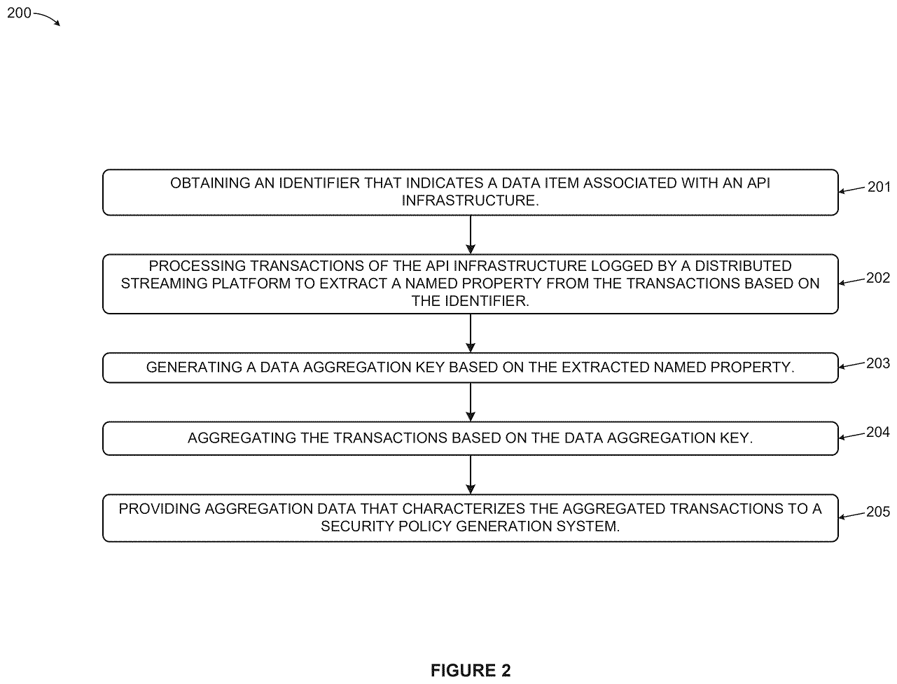

In some examples, system 100 implements process 200 illustrated in FIG. 2. It should be appreciated that the structure and operation of system 100 may differ in other examples.

FIG. 2 illustrates process 200. Process 200 comprises an exemplary operation of system 100 to aggregate transactions logged by a distributed streaming platform. The operation may vary in other examples. The operations of process 200 comprise obtaining an identifier that indicates a data item associated with an API infrastructure (step 201). The operations further comprise processing transactions of the API infrastructure logged by a distributed streaming platform to extract a named property from the transaction based on the identifier (step 202). The operations further comprise generating a data aggregation key based on the extracted named property (step 203). The operations further comprise aggregating the transactions based on the data aggregation key (step 204). The operations further comprise providing aggregation data that characterizes the aggregated transactions to a security policy generation system (step 205).

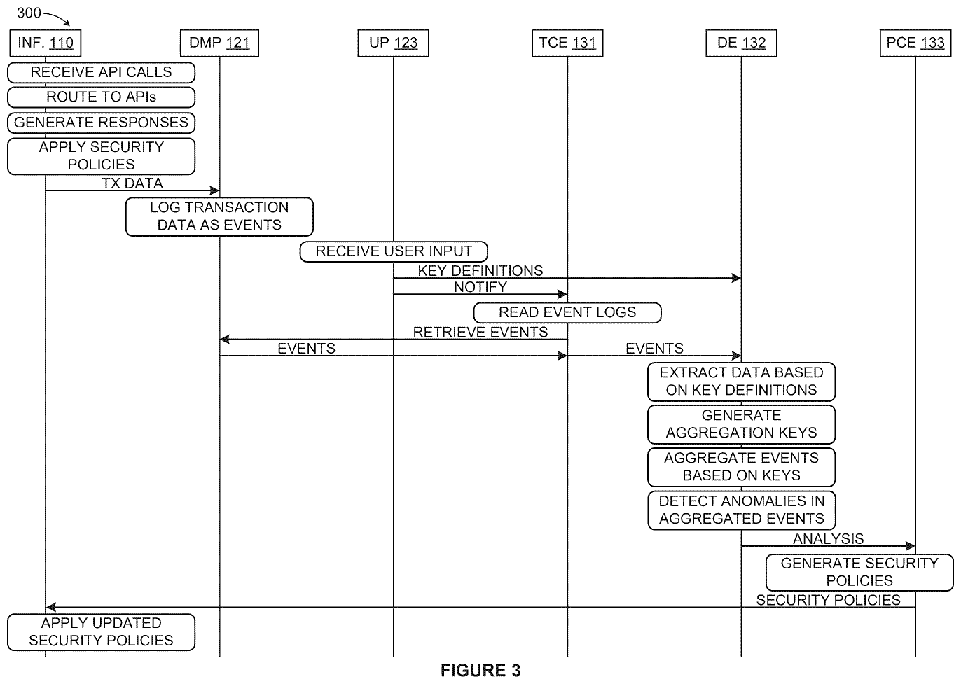

FIG. 3 illustrates process 300. Process 300 comprises an exemplary operation of system 100 to aggregate transactions logged by a distributed streaming platform. Process 300 comprises an example of process 200 illustrated in FIG. 2, however process 200 may differ. In other examples, process 300 may differ. In some examples, API gateway 111 in API infrastructure (INF.) 110 receives API calls from user systems 101. Gateway 111 passes the calls to APIs 112-114 which generate API responses based on their functionality and the calls. APIs 112-114 pass the calls through security proxy 115 which enforces security policies on the responses to mitigate malicious activity within API infrastructure 110. API gateway 111 copies transaction (TX) data to distributed messaging platform 121. The transaction data characterizes the requests and responses received and produced by APIs 112-114 and includes timestamps for each of the transactions. Distributed messaging platform (DMP) 121 stores the transactions as temporally ordered events in logs 122. For example, distributed messaging platform 121 logs an event that occurs earlier in time before logging an event that occurs later in time.

User portal (UP) 123 receives a user input selecting a key aggregation definition. The key aggregation definition comprises a set of user defined parameters to sort the transactions of APIs 112-114. Exemplary key aggregation definitions include credit card numbers, banking routing numbers, user Identifiers (IDs), Internet Protocol (IP) addresses, host names, Uniform Resource Locators (URLs), Uniform Resource Indicators (URIs), and the like. For example, user portal 123 may display a Graphical User Interface (GUI) with selectable options that allow a user to specify a set of aggregation key definitions. User portal 123 provides the aggregation key definition to security pipeline 130. In response, traffic capture engine (TCE) 131 queries distributed messaging platform 121 to retrieve the events (e.g., transaction processed by APIs 112-114) stored by transaction logs 122.

Detection engine (DE) 132 extracts data from the retrieved events that correspond to the aggregation key definitions. Detection engine 132 generates aggregation keys that comprise the data extracted from the retrieved events. Detection engine 132 aggregates (e.g., groups) the events based on the aggregation keys. By aggregating the events, detection engine 132 may generate data that indicates anomalous behavior in API infrastructure 110. For example, the aggregated events may indicate threshold levels of atypical requests received by API 112. Detection engine 132 processes the aggregated events to generate analysis results that indicate when anomalous behavior occurs in API infrastructure 110 and forwards the results to policy creation engine 133. In some examples, detection engine 132 may extract data values from the events in a manner similar to aggregation key extraction. For example, detection engine 132 may receive the aggregation key definition identifying International Mobile Equipment Identifier (IMEI) as the key definition via user portal 123. Detection engine 132 may then extract a key from the events to aggregate events by IMEI and also extract the IMEI values themselves from the events. Detection engine 132 may then aggregate the events by IMEI using the aggregation key and aggregate the IMEI values extracted from the events.

Policy creation engine (PCE) 133 receives the analysis results from detection engine 132. Policy creation engine 133 generates updated security polices based on the analysis results. Policy creation engine 133 delivers the updated security policies to security proxy 115. For example, policy creation engine 133 may generate policies to block API requests associated with bot activity, malicious or otherwise unwanted API behavior, and the like. Security proxy 115 enforces the updated security policies on the API calls and API responses handled by APIs 112-114.

Advantageously, security platform 120 efficiently leverages their distributed streaming platforms to inhibit unwanted API behavior. Moreover, security platform 120 effectively aggregates and tracks transactions processed by API 112-114 logged by a distributed streaming platform based on user defined parameters.

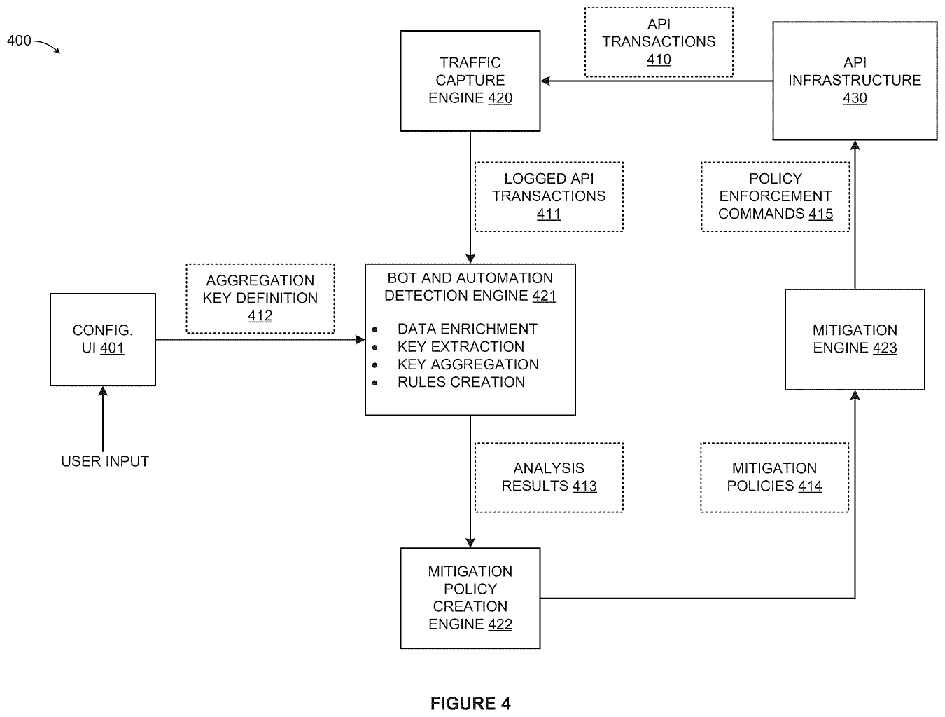

FIG. 4 illustrates data aggregation system 400 to aggregate transactions logged by a distributed streaming platform. Data aggregation system 400 comprises an example of system 100 illustrated in FIG. 1, however system 100 may differ. Data aggregation system 400 comprises configuration User Interface (UI) 401, API transactions 410, logged API requests 411, aggregation key definition 412, analysis results 413, mitigation policies 414, policy enforcement commands 415, traffic capture engine 420, bot and automation detection engine 421, mitigation policy creation engine 422, mitigation engine 423, and API infrastructure 430. In other examples, data aggregation system 400 may differ.

In some examples, API infrastructure 430 receives API calls from requesting entities, routes the API calls to its constituent APIs to generate responses, and provides the API responses to the requesting entities. For example, API infrastructure 430 may receive an API get request from user devices for information, provide the get requests to the appropriate GET API to retrieve the requested information, and return an API response to the user device with the requested information. The API calls, API operations, and API responses are provided to traffic capture engine 420 as API transactions 410. Typically, API infrastructure 430 writes API transaction 410 to a distributed streaming platform which records API transactions 410 as a time series of events to create a record of API infrastructure 430's operations. Traffic capture engine 420 then reads the events stored by the distributed streaming platform to obtain the API transactions.

A user associated with API infrastructure 430 provides a user input to configuration UI 401 that defines aggregation key definition 412. Aggregation key definition 412 defines data items present in transactions (e.g., responses, requests, and the like) of API infrastructure 430. For example, aggregation key definition 412 may define credit card numbers, banking routing numbers, user IDs, IP addresses, host names, URLs, URIs, and the like. Typically, aggregation key definition 430 identifies security relevant data items for API infrastructure 410. For example, if API infrastructure 410 comprises a payment processing enterprise, the user may select a data aggregation key definition that includes bank routing numbers and credit card numbers.

Bot and automation detection engine 421 obtains aggregation key definition 412 from configuration UE 401 and obtains logged API transactions 411 from traffic capture engine 420. For example, traffic capture engine 420 may read transactions logged by a distributed streaming platform and forward the transactions to detection engine 421. Bot and automation detection engine 421 comprises capabilities for data enrichment, key extraction, key aggregation, and rules generation. Bot and automation detection engine 421 extracts relevant information from logged API transactions 410 based on aggregation key definition 412. For example, bot and automation detection engine 421 process logged transactions 411 to identify ones of logged transactions 411 that comprise data items (e.g., field names in headers or bodies, IP addresses, financial account numbers, user/device identity numbers, etc.) that match aggregation key definition 412. Bot and automation detection engine 421 generates a data aggregation key using the extractions. The data aggregation key comprises one or more of the named extractions identified based on aggregation key definition 412 provided by the user via configuration UI 401. A topology (or flow of data) through the distributed streaming platform is defined before events are processed by system 400. This means that the aggregation keys and topics are defined from configuration or discrete data elements that are known to be available during the development process. As such, aggregation key definition 412 provided by the user may not typically be directly used to aggregate transactions, and instead, extractions from logged transactions 420 that correspond to the user definition are used for transaction aggregation.

Bot and automation detection engine 421 aggregates transactions using the aggregation key and generates analysis results 413 that characterizes the aggregated transactions. For example, bot and automation detection engine 421 may use the aggregation key to perform unique value aggregation, condition aggregation, statistical aggregation, and the like. Unique value aggregation comprises a rolling count of unique values grouped by aggregation key (e.g., the count of unique IP addresses by host name) The unique value can be from well-known properties of HTTP, or can be the result of data extraction. Condition aggregation comprises a rolling count of custom rule conditions grouped by aggregation key (e.g., the count of unauthenticated requests by URI). Statistical aggregation comprises a rolling transaction count grouped by aggregation key (e.g., a count per IP address). In general, analysis results 413 indicate the data flow through API infrastructure 430 associated with the user that meets aggregation key definition 412. The data flow can be used to define normal operating behavior and detect anomalous behavior in API infrastructure 430 in real time or near real time, in particular, anomalous behavior relating to the particular business operation associated with API infrastructure 430. Bot and automation detection engine 421 may also extract and aggregate data values from the transactions in a similar manner to aggregation key extraction and transaction aggregation. For example, bot detection engine 421 may extract and aggregate actual values from the transactions of credit card numbers, banking routing numbers, user IDs, IP addresses, host names, URLs, URIs, and/or other data defined by the aggregation key definition.

Bot and automation detection engine 421 provides the analysis results to mitigation policy creation engine 422. Policy creation engine 422 generates mitigation policies 414 to combat any anomalies in API infrastructure 430 based on analysis results 413. For example, analysis results 413 may indicate an abnormally high count of unauthenticated requests by a particular IP address (i.e., indicating bot activity) and policy creation engine 413 may generate a policy to block requests from that IP address. Mitigation policy creation engine 422 may be autonomous, semi-autonomous, or user controlled. Mitigation policy creation engine 422 may host one or more machine learning models trained to generate mitigation policies 414 based on analysis results 413. Mitigation policy creation engine 422 provides mitigation policies 414 to mitigation engine 423. Mitigation engine 423 enforces mitigation policies 414 by transferring policy enforcement commands 415 to API infrastructure 430 (e.g., via security proxies, API gateways, etc.) to mitigate anomalous or otherwise unwanted API traffic.

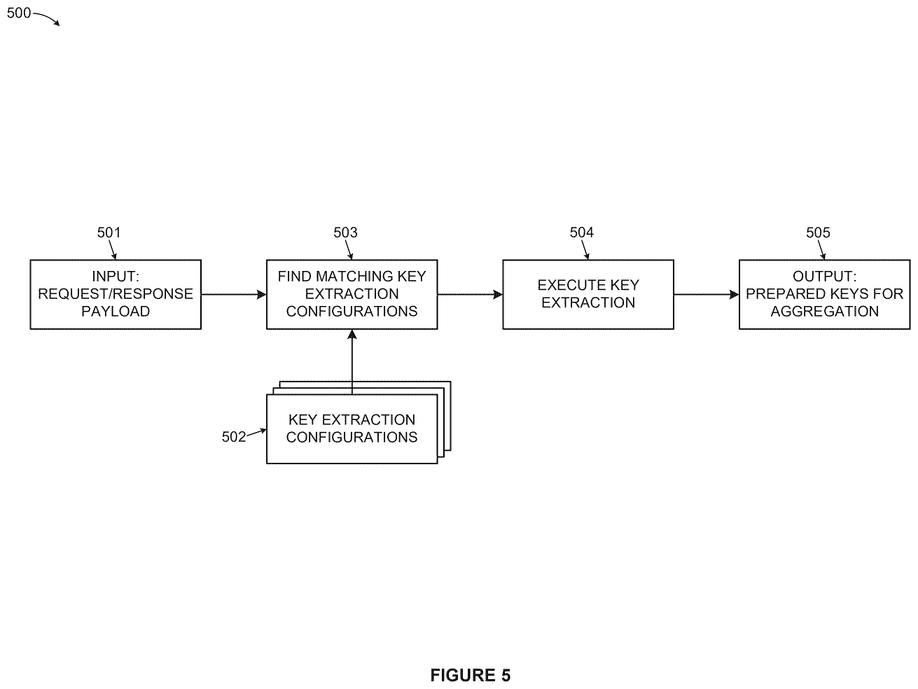

FIG. 5 illustrates aggregation key extraction process 500 to generate aggregation keys for use in aggregating transactions logged by a distributed streaming platform. For example, process 500 may be implemented by the one or more software and hardware components that compose security platform 120 illustrated in FIG. 1 and/or bot and automation detection engine 421 illustrated in FIG. 4. The operations of process 500 comprise receiving an input that comprises an API request/response payload (step 501). The operations further comprise receiving key extraction configurations (step 502). The key extraction configurations define data types in the requests/responses that are to be extracted to form aggregation keys. The configurations may be user-defined or automatically defined (e.g., by machine learning techniques). The key extraction configurations typically relate to a specific business operation associated with the APIs. For example, if the APIs are associated with an online banking service, the key extraction configurations may comprise account numbers, routing numbers, and the like. The operations further comprise finding matching key extraction configurations in the request/response payload (step 503). For example, finding the matching configurations may comprise performing a keyword search on the payload to identify portions of the payload that match or otherwise correspond to the configurations. The operations further comprise executing the key extraction (step 504). Executing the key extraction extracts the portions of the payload identified in step 503. The operations further comprise generating aggregation keys comprising the extracted portions of the payload (step 505). The aggregation keys may correspond to the key extraction configurations on a one-to-one basis. The aggregation keys may then be used to aggregate events logged by a distributed streaming platform to identify anomalous or otherwise unwanted API behavior.

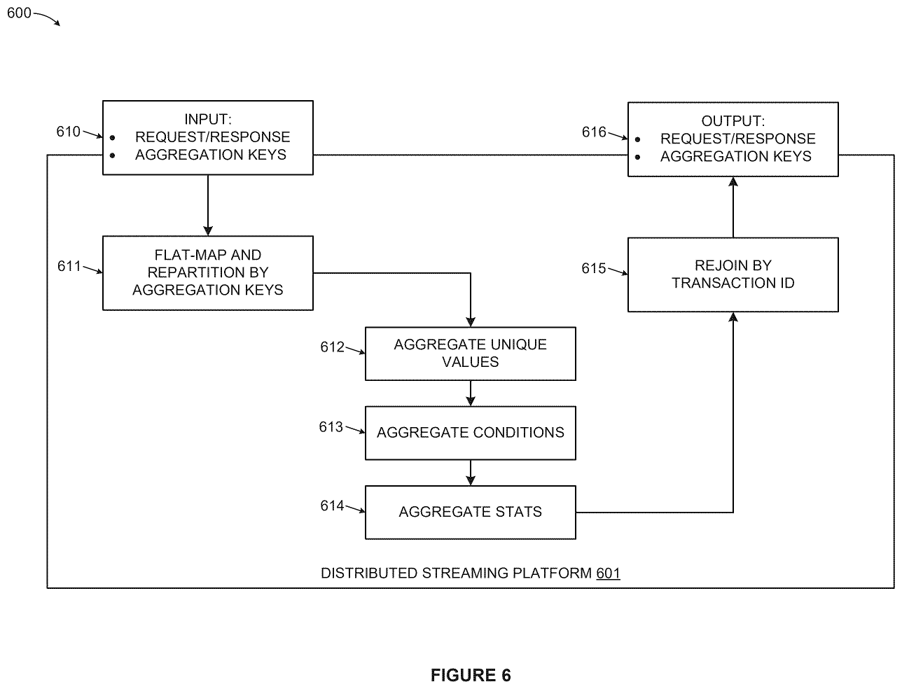

FIG. 6 illustrates system 600 to aggregate transactions. System 600 comprises distributed streaming platform 601, input 610, and output 616. Distributed streaming platform 601 comprises flat-map and repartition module 611, unique value aggregation module 612, condition aggregation module 613, statistics aggregation module 614, and transaction rejoining module 615. Distributed streaming platform 601 is an example of detection engine 132 illustrated in FIG. 1, however detection engine 132 may differ. In other examples, platform 601 may differ. In some examples, distributed streaming platform receives input 610. Input 610 comprises API requests/responses and aggregation keys. Distributed streaming platform 601 stores the API requests/responses as a temporally ordered series of events. In response to receiving the aggregation keys, module 611 flat-maps and repartitions the events based on the aggregation keys. For example, module 611 may examine each of the events and select ones of the events that comprise named data items (e.g., fields) that correspond to the aggregation keys. Module 611 passes the aggregated events to unique value aggregation module 612. Module 612 processes the aggregated events to determine the number of unique values in the events based on the aggregation keys. Module 612 indicates the aggregated events and unique values to condition aggregation module 613. Module 613 processes the aggregated events to determine the number of conditions (e.g., number of unauthorized requests, number of API response types, etc.) in the events based on the aggregation keys. Module 613 indicates the aggregated events, unique values, and conditions to statistics aggregation module 614. Module 614 processes the aggregated events to aggregate statistics based on the aggregation keys. Module 614 indicates the aggregated events, unique values, conditions, and statistics to transaction rejoining module 615. Module 615 rejoins the events based on transaction ID and produces output 616. Output 616 indicates the aggregated events, unique values, conditions, and statistics. Distributed streaming platform 601 transfers the output to downstream systems.

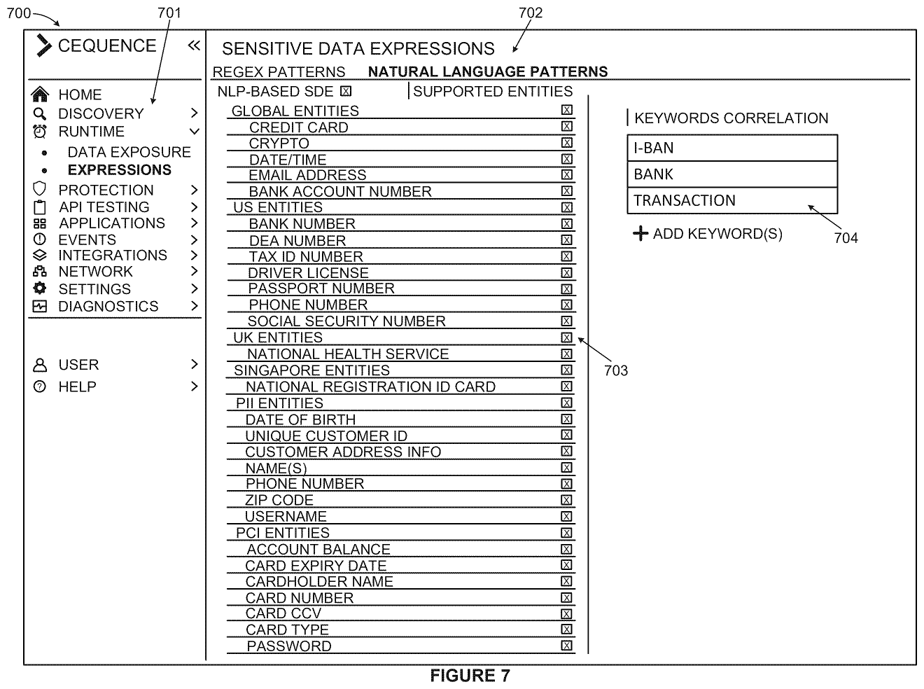

FIGS. 7-14 illustrate GUIs for selecting aggregation key definitions and displaying aggregation results. The GUIs may be displayed on computing devices with user interface systems like personal computers, laptops, smartphones, and the like. Exemplary user interface systems include display screens, touch screens, keyboards, computer mice, and the like. For example, the computing devices may be representative of user portal 123 illustrated in FIG. 1 or configuration UI 401 illustrated in FIG. 4. The GUIs may be generated by user applications hosted on the computing device and/or may be generated via an application server and accessed by the computing device via an internet browser application hosted by the computing device.

FIG. 7 illustrates GUI 700. GUI 700 comprises side panel 701, top bar 702, entity selection element 703, and keyword correlation element 704. The layout of GUI 700 may differ in other examples. In other examples, GUI 700 comprises different or additional GUI features than those illustrated in FIG. 7. In some examples, side panel 701 comprises a navigation panel with selectable options that allow a user to access the various features of GUI 700. The selectable options are representative of drop-down menus and comprise options for discovery, runtime, protection, API testing, applications, events, integrations, network, settings, diagnostics, user, and help. Upon receiving a user input for one of the selectable options, that selectable option opens its drop-down menu. In this example, a user has selected the runtime option to reveal its drop-down menu. The runtime option drop-down menu includes selectable options for data exposure and expressions. In this example, a user has selected the expressions options which drove GUI 700 to display top bar 702 and elements 703 and 704. In other example, the runtime option drop-down menu may include additional selectable options like dashboard, API inventory, and the like.

Top bar 702 comprises the label, “sensitive data expressions” to indicate the expressions option in side panel 701 was selected and comprises selectable options for Regular Expression (REGEX) patterns and natural language patterns. These two selectable options allow a user to specify which type of aggregation keys they would like to define. The natural language patterns option allows a user to input human or otherwise natural language expressions to define aggregation keys. In this example, the user has selected the natural language patterns option causing GUI 700 to display elements 703 and 704.

Entity selection element 703 comprises a number of toggles to select elements in API transactions logged by a distributed streaming platform that will be examined to extract aggregation keys. The toggles are organized in global entities, US entities, UK entities, Singapore entities, PII entities, and PCI entities. The global entities comprise toggles for credit card, crypto, data/time, email address, and bank account number. The US entities comprise toggles for bank number, DEA number, tax ID number, driver license, passport number, phone number, and social security number. The UK entities comprise a toggle from national health service. The Singapore entities comprise a toggle for national registration ID card. The PII entities comprise toggles for date of birth, unique customer ID, customer address info, name(s), phone number, zip code, and username. The PCI entities comprise toggles for account balance, card expiry data, cardholder name, card number, card CCV, card type, and password. The PCI entities typically comprise additional toggles for credit score, gift card, and tracking/order ID, however these additional toggles are omitted for clarity. As illustrated in FIG. 4, the user has selected every toggle in entity selection element 703.

Keyword correlation element 704 comprises selectable options to define and add keywords to form aggregation key definitions. Keyword correlation element 704 comprises text input boxes that a user may type the keywords into and comprise an add keywords toggle to display additional text input boxes. In this example, the user has typed in the keywords I-BAN, bank, and transaction. Once the entities and keywords are entered, GUI 700 may provide the user selections to a detection engine (e.g., bot and automation detection engine 421) to extract data elements from logged API transactions based on the user selected definitions and generate aggregation keys based on the extracted data elements.

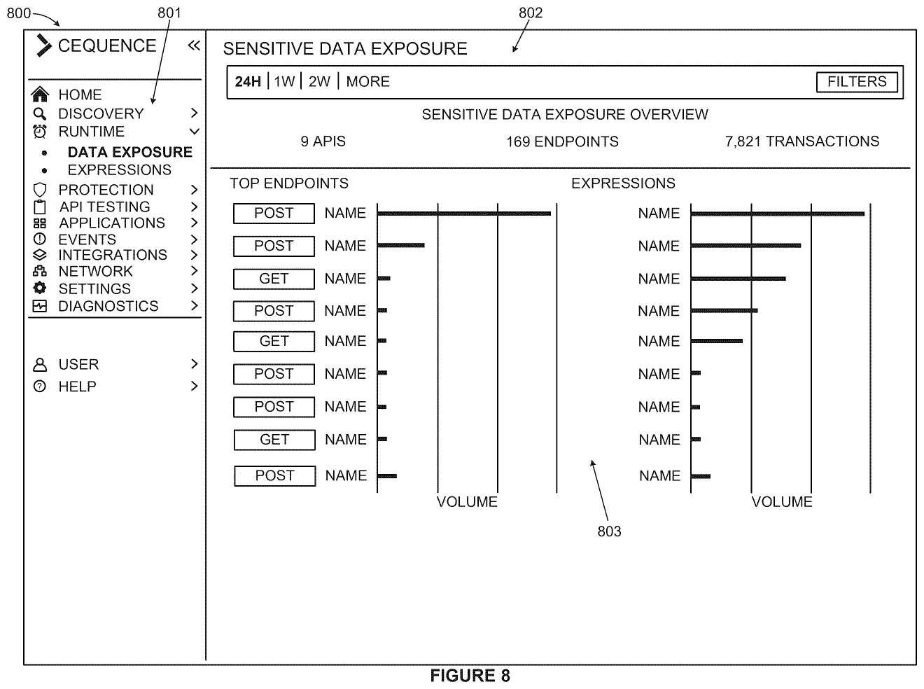

FIG. 8 illustrates GUI 800. GUI 800 comprises side panel 801, top bar 802, and sensitive data exposure element 803. GUI 800 comprises an example of GUI 700 illustrated in FIG. 7, however GUI 700 may differ. The layout of GUI 800 may differ in other examples. In other examples, GUI 800 comprises different or additional GUI features than those illustrated in FIG. 8. In some examples, side panel 801 is similar to side panel 701 illustrated in FIG. 7, however a user has instead selected the data exposure selectable option in the runtime drop down menu. As a result, GUI 800 displays top bar 802. Top bar 802 comprises the label, “sensitive data exposure” to indicate the data exposure option in side panel 801 was selected. Top bar 802 comprises selectable options to select a time period to view data exposure events. The time periods comprise 24 hours, one week, and two weeks. In this example, the user has selected the 24-hour time period and GUI 800 displays element 803 and modifies top bar 802 to indicate that there are 9 APIs, 169 endpoints, and 7,821 API transactions. It should be appreciated that these numbers are exemplary and may differ in other examples. Sensitive data exposure element 803 comprises a graphical element that illustrates the sensitive data exposure volume for the top nine endpoints and top nine expressions. The listed endpoints include API types (in this example either POST or GET) and the names of the API endpoints. The listed expressions (e.g., data elements within API transactions) each comprise a name and are selected based on user input. For example, the expressions may correspond to the toggles in entity selection element 703 GUI 700 selected by a user.

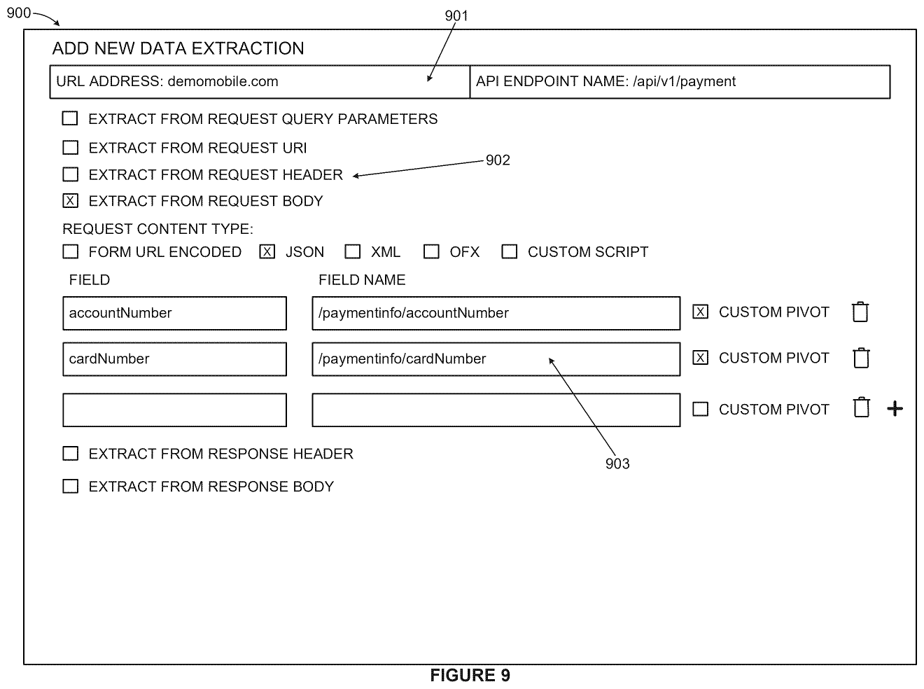

FIG. 9 illustrates GUI 900. GUI 900 comprises API selection bar 901, extraction selection options 902, and extraction definitions 903. GUI 900 comprises an example of GUIs 700 and 800 illustrated in FIGS. 7 and 8, however GUIs 700 and 800 may differ. The layout of GUI 900 may differ in other examples. In other examples, GUI 900 comprises different or additional GUI features than those illustrated in FIG. 9. In some examples, GUI 900 is used to add extraction definitions which can be used to generate aggregation keys. GUI 900 allows users to specify which data values is elevated into a real time aggregation stream. The user is able to configure the key of the pivot, and all values that will be counted. The keys in this pivot may be multi-level keys (e.g., five levels in depth). API selection bar 901 comprises a text input bar where a user can input a URL address and an API endpoint name. The address and endpoint name specify where the key definition is to be extracted from. Extraction selection options 902 comprise a set of toggles that indicate what portions of the API transactions (e.g., the requests/responses for the URL/API selected in API selection bar 901) the extraction is to be performed on. The set of toggles comprises extract from request query parameters, extract from request URI, extract from request header, extract from request body, extract from response header, and extract from response body. In this example, the user had selected the extract from request body toggle. In other examples, the user may select additional or different toggles. In response to the user selection, GUI 900 displays extraction definitions 903. Extraction definitions 903 comprises a set of toggles to define the content type that is to be extracted as well as text input bars to define the fields and field names where the extraction is to occur. The content type toggles comprise form URL encoded, JSON, XML, OFX, and custom script. In this example, the user selected JSON as the content type but may select a different or additional content types in other examples. Extraction definitions 903 also includes selectable options to add additional text input boxes, delete exiting text input boxes, and toggles to define the fields and field names as custom pivots which drives the system to extract aggregation keys and aggregate transactions based on these aggregation key definitions.

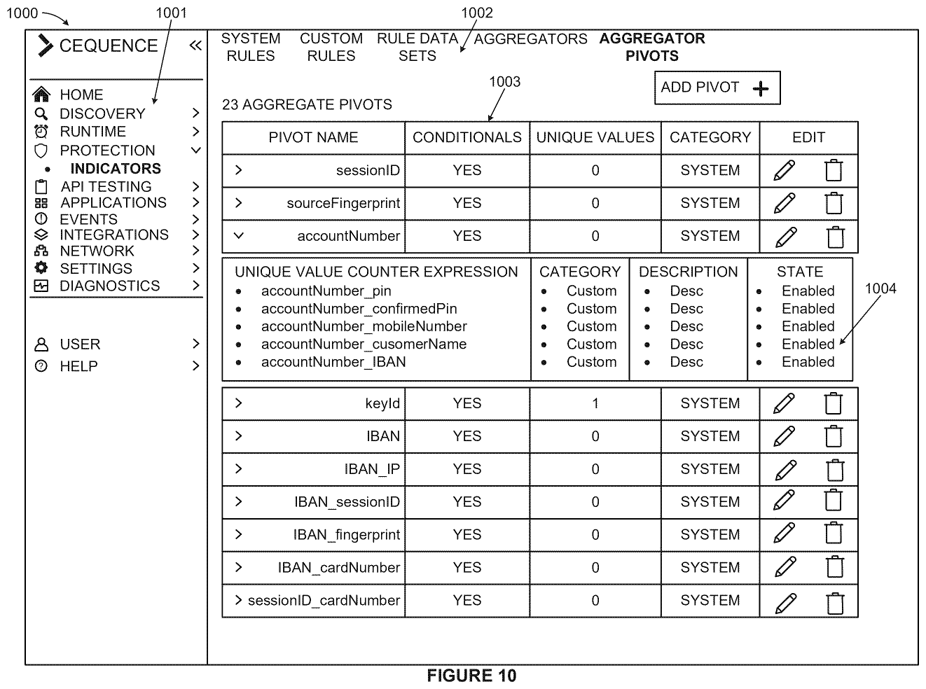

FIG. 10 illustrates GUI 1000. GUI 1000 comprises side panel 1001, top bar 1002, aggregate pivots 1003, and pivot details 1004. GUI 1000 comprises an example of GUIs 700 800, and 900 illustrated in FIGS. 7-9, however GUIs 700, 800, and 900 may differ. The layout of GUI 1000 may differ in other examples. In other examples, GUI 1000 comprises different or additional GUI features than those illustrated in FIG. 10. In some examples, side panel 1001 is similar to side panels 701 and 801 illustrated in FIGS. 7 and 8, however a user has instead selected the indicators selectable option in the protection drop down menu. As a result, GUI 1001 displays top bar 1002. Top bar 1002 comprises a set of selectable options to modify the view of GUI 1000. The selectable options comprise system rules, custom rules, rule data sets, aggregators, and aggregator pivots. In this example, a user has selected aggregator pivots to display aggregate pivots 1003. Aggregate pivots 1003 comprises a table with columns for pivot name, conditionals, unique values, category, and edit. The pivot name column lists the fields in the API transactions aggregated by the system based on the aggregation key definition supplied by the user. Each pivot name is selectable to reveal pivot details for the selected pivot. In this example, the user selected the accountNumber pivot to reveal pivot details 1004. The conditionals column indicates if condition aggregation is enabled. The unique values column indicates the number of unique values aggregated in the transactions. The category column indicates whether the pivot is a system/default pivot or a custom user defined pivot. The edit column comprises selectable options to delete or modify each pivot.

Pivot details 1004 comprises a table that includes information characterizing the selected pivot which in this example is the accountNumber pivot. The columns of the table comprise unique value counter expression, category, description, and state. The unique value counter expression column defines the various named data items that are being aggregated. The category column indicates whether the expressions are custom (e.g., user defined) or default. The decision column comprises written descriptions that describe the expressions. The state column indicates whether the expressions are enabled or disabled.

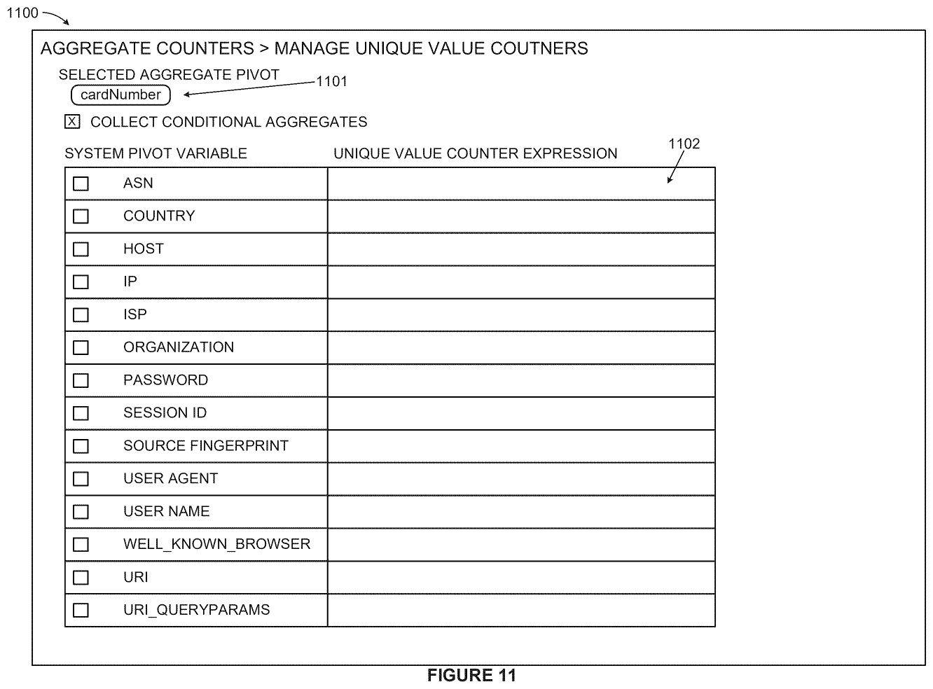

FIG. 11 illustrates GUI 1100. GUI 1100 comprises indicator 1101 and aggregate table 1102. GUI 1100 comprises an example of GUIs 700 800, 900, and 1000 illustrated in FIGS. 7-10, however GUIs 700, 800, 900, and 1000 may differ. The layout of GUI 1100 may differ in other examples. In other examples, GUI 1100 comprises different or additional GUI features than those illustrated in FIG. 11. In some examples, GUI 1100 comprises functionality to manage unique values aggregated based on the user defined aggregation keys. Indicator 1101 identifies the aggregator selected by the user. Aggregator table 1102 lists system (i.e., default) variables which may be selected to aggregate unique values. In this example, the user has not selected any system variables to aggregate unique values by, however in other examples, the user may select system variables for aggregation. For example, a user may select the pivot variable URI and define a unique value counter expression for URI to extract and aggregate URIs in the aggregator defined by indicator 1101.

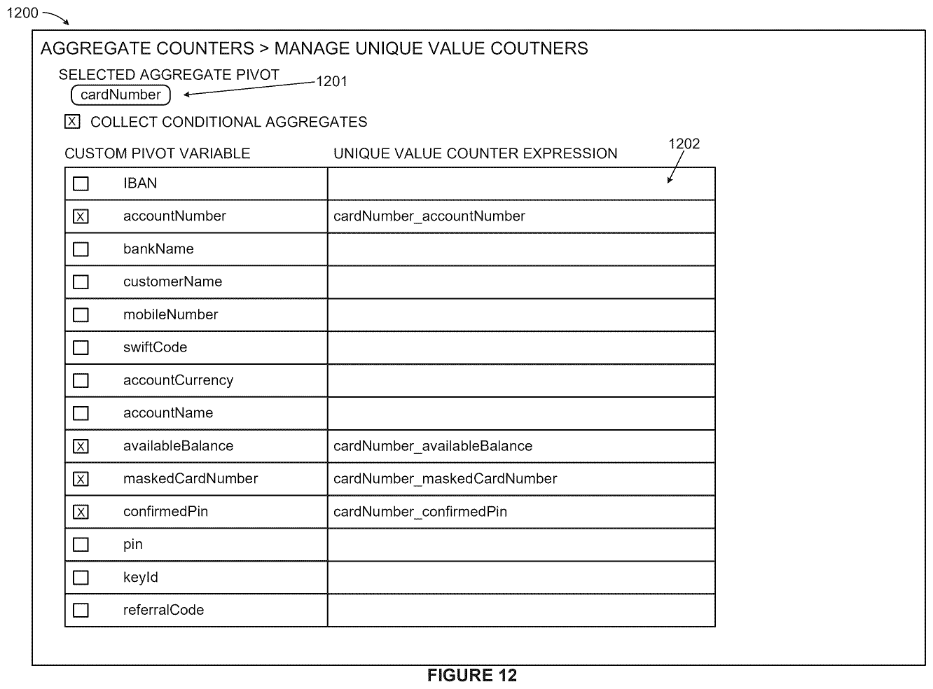

FIG. 12 illustrates GUI 1200. GUI 1200 comprises indicator 1201 and aggregate table 1202. GUI 1200 comprises an example of GUIs 700 800, 900, 1000, and 1100 illustrated in FIGS. 7-11, however GUIs 700 800, 900, 1000, and 1100 may differ. The layout of GUI 1200 may differ in other examples. In other examples, GUI 1200 comprises different or additional GUI features than those illustrated in FIG. 12. In some examples, GUI 1200 comprises similar functionality to GUI 1100 illustrated in FIG. 11. Indicator 1201 identifies the aggregator selected by the user. Aggregator table 1202 lists custom variables which may be selected to aggregate unique values. In this example, the user selected the pivot variables accountNumber, availableBalance, maskedCardNumber, and confirmedPin and defined a unique value counter expressions for the selected pivots to extract and aggregate data from the aggregator defined by indicator 1201.

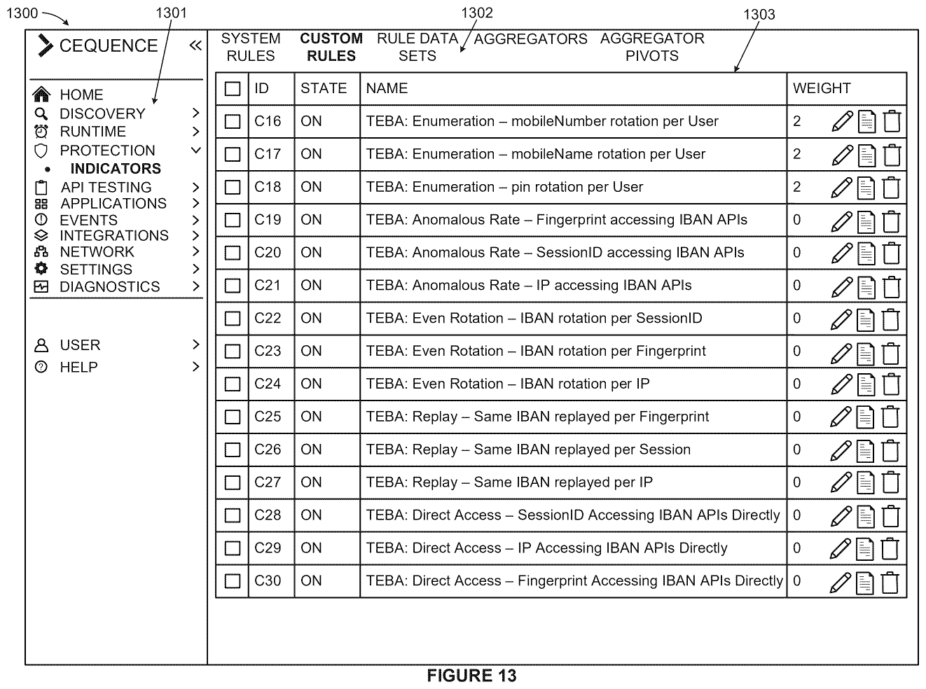

FIG. 13 illustrates GUI 1300. GUI 1300 comprises indicator 1301, top bar 1302, and custom rules table 1303. GUI 1300 comprises an example of GUIs 700 800, 900, 1000, 1100, and 1200 illustrated in FIGS. 7-12, however GUIs 700 800, 900, 1000, 1100, and 1200 may differ. The layout of GUI 1200 may differ in other examples. In other examples, GUI 1200 comprises different or additional GUI features than those illustrated in FIG. 12. In some examples, side panel 1301 is similar to side panels 701, 801, and 1001 illustrated in FIGS. 7, 8, and 10, however a user has instead selected the indicators selectable option in the protection drop down menu. As a result, GUI 1301 displays top bar 1302. Top bar 1302 comprises a set of selectable options to modify the view of GUI 1300. The selectable options comprise system rules, custom rules, rule data sets, aggregators, and aggregator pivots. In this example, a user has selected custom rules to display custom rules table 1303. Custom rules table comprises columns for rule ID, state, name, and weight. The ID column indicates the ID for each of the custom rules. The state columns indicate whether the rules are active or not. The name column comprises the names for each of the custom rules. The weight column indicates the weights for the custom rules and includes selectable options to edit or delete the custom rules.

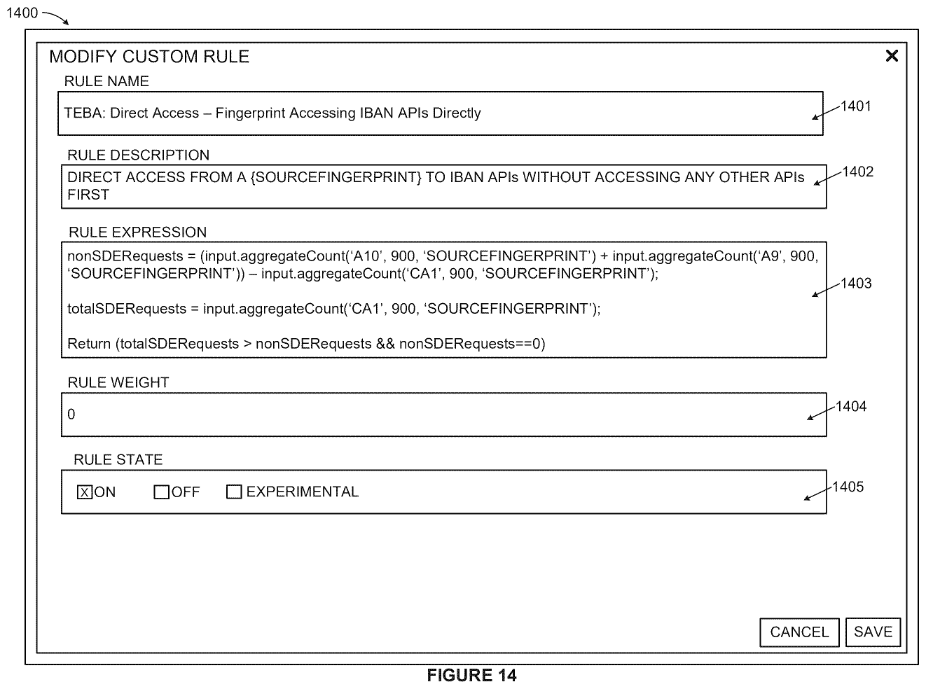

FIG. 14 illustrates GUI 1400. GUI 1400 comprises rule name 1401, rule description 1402, rule expression 1403, rule weight 1404, and rule state 1405. GUI 1400 comprises an example of GUIs 700 800, 900, 1000, 1100, 1200, and 1300 illustrated in FIGS. 7-13, however GUIs 700 800, 900, 1000, 1100, 1200, and 1300 may differ. The layout of GUI 1400 may differ in other examples. In other examples, GUI 1400 comprises different or additional GUI features than those illustrated in FIG. 14. In some examples, GUI 1400 comprises capabilities to modify custom rules generated by the user. For example, a user may select one of the selectable options in the weight column in custom rule table 1303 to display GUI 1400. GUI 1400 allows users to encode complex behavioral logic into the real time detection engine, using the previously created keys and pivots. This behavioral detection logic is used to detect sophisticated API abuse, and separating legitimate automation from malicious automation. For example, GUI 1400 may show the detection of enumeration of PIN/AccountNum values per User or Session. GUI 1400 may also show behaviors to indicate where a business value is being called in a flow before it should be. These behavioral rules are representative of business logic violations that security professionals want to be able to enforce in their applications to prevent abuse and exploitation. Rule name 1401 comprises an editable text box that indicates the name of the custom rule. Description 1402 comprises an editable text box that describes the custom rule. Rule expression 1403 comprise an editable text box with code that defines the custom rule. Rule weight 1404 comprises an editable text box to weight the custom rule. Rule state 1405 comprises toggles to enable and disable the custom rule.

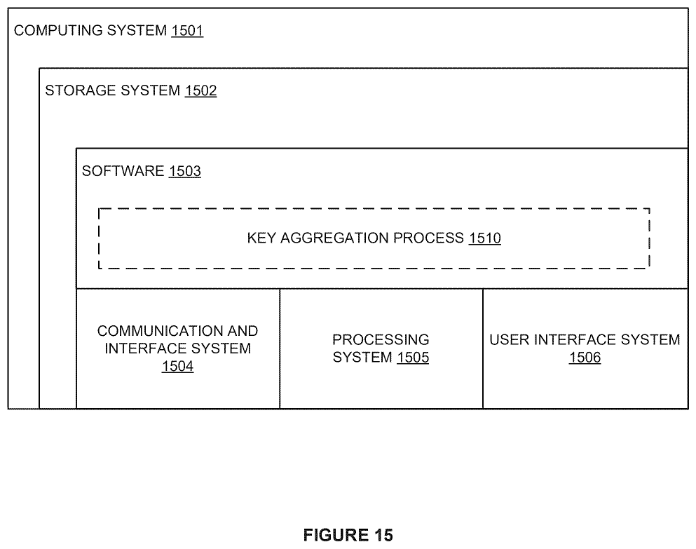

FIG. 15 illustrates computing device 1501 which is representative of any system or collection of systems in which the various processes, programs, services, and scenarios disclosed herein to aggregate transactions logged by a distributed streaming platform. For example, computing device 1501 may be representative of API infrastructure 110, platform 120, system 400, platform 601, the computing systems that host GUIs 700, 800, 900, 1000, 1100, 1200, 1300, 1400, and/or any other computing device contemplated herein. Examples of computing system 1501 include, but are not limited to, server computers, routers, web servers, cloud computing platforms, and data center equipment, as well as any other type of physical or virtual server machine, physical or virtual router, container, and any variation or combination thereof.

Computing system 1501 may be implemented as a single apparatus, system, or device or may be implemented in a distributed manner as multiple apparatuses, systems, or devices. Computing system 1501 includes, but is not limited to, storage system 1502, software 1503, communication and interface system 1504, processing system 1505, and user interface system 1506. Processing system 1505 is operatively coupled with storage system 1502, communication interface system 1504, and user interface system 1506.

Processing system 1505 loads and executes software 1503 from storage system 1502. Software 1503 includes and implements key aggregation process 1510, which is representative of the processes to aggregate transactions logged by a distributed streaming platform as described in the preceding Figures. For example, key aggregation process 1510 may be representative of process 200 illustrated in FIG. 2, process 300 illustrated in FIG. 3, and/or process 500 illustrated in FIG. 5. When executed by processing system 1505, software 1503 directs processing system 1505 to operate as described herein for at least the various processes, operational scenarios, and sequences discussed in the foregoing implementations. Computing system 1501 may optionally include additional devices, features, or functionality not discussed here for purposes of brevity.

Processing system 1505 may comprise a micro-processor and other circuitry that retrieves and executes software 1503 from storage system 1502. Processing system 1505 may be implemented within a single processing device but may also be distributed across multiple processing devices or sub-systems that cooperate in executing program instructions. Examples of processing system 1505 include general purpose central processing units, graphical processing units, application specific processors, and logic devices, as well as any other type of processing device, combinations, or variations thereof.

Storage system 1502 may comprise any computer readable storage media that is readable by processing system 1505 and capable of storing software 1503. Storage system 1502 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1502 may also include computer readable communication media over which at least some of software 1503 may be communicated internally or externally. Storage system 1502 may be implemented as a single storage device but may also be implemented across multiple storage devices or sub-systems co-located or distributed relative to each other. Storage system 1502 may comprise additional elements, such as a controller capable of communicating with processing system 1505 or possibly other systems.

Software 1503 (kay aggregation process 1510) may be implemented in program instructions and among other functions may, when executed by processing system 1505, direct processing system 1505 to operate as described with respect to the various operational scenarios, sequences, and processes illustrated herein. For example, software 1503 may include program instructions for generating aggregation keys using request/response payload extractions and aggregating request/response payloads using the resulting keys as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1503 may include additional processes, programs, or components, such as operating system software, virtualization software, or other application software. Software 1503 may also comprise firmware or some other form of machine-readable processing instructions executable by processing system 1505.

In general, software 1503 may, when loaded into processing system 1505 and executed, transform a suitable apparatus, system, or device (of which computing system 1501 is representative) overall from a general-purpose computing system into a special-purpose computing system customized to aggregate transactions logged by a distributed streaming platform as described herein. Indeed, encoding software 1503 on storage system 1502 may transform the physical structure of storage system 1502. The specific transformation of the physical structure may depend on various factors in different implementations of this description. Examples of such factors may include, but are not limited to, the technology used to implement the storage media of storage system 1502 and whether the computer-storage media are characterized as primary or secondary storage, as well as other factors.

For example, if the computer readable storage media are implemented as semiconductor-based memory, software 1503 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1504 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of computing devices to aggregate transactions logged by a distributed streaming platform, it should be understood that the systems and methods described herein are not limited to such embodiments and may apply to a variety of other extension implementation environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method to aggregate transactions logged by a distributed streaming platform, the method comprising:
obtaining an identifier that indicates a data item associated with an Application Programming Interface (API) infrastructure;
processing the transactions of the API infrastructure logged by the distributed streaming platform to extract a named property from the transactions based on the identifier;
generating a data aggregation key based on the extracted named property;
aggregating the transactions based on the data aggregation key; and
providing aggregation data that characterizes the aggregated transactions to a security policy generation system.

2. The method of claim 1 further comprising displaying a user interface that comprises selectable options to select one or more identifiers that indicate data items associated with the API infrastructure; and wherein:
obtaining the identifier that indicates the data item associated with the API infrastructure comprises receiving a user input via the user interface that selects the identifier that indicates the data item associated with the API infrastructure.

3. The method of claim 1 further comprising:
generating security policies based on the aggregation data to block unauthorized API requests to the API infrastructure; and
providing the security policies to the API infrastructure wherein the API infrastructure enforces the security policies to block the unauthorized API requests.

4. The method of claim 1 further comprising:
generating security policies based on the aggregation data to block an API request originating from a bot to the API infrastructure; and
providing the security policies to the API infrastructure wherein the API infrastructure enforces the security policies to block the API request originating from the bot.

5. The method of claim 1 wherein the aggregation data comprises a count of unique values in the aggregated transactions.

6. The method of claim 1 wherein the aggregation data comprises a count of conditions in the aggregated transactions.

7. The method of claim 1 wherein the named property from the transactions comprises a named field located in the body or the header of the transactions.

8. A system to aggregate transactions logged by a distributed streaming platform, the system comprising:
processing circuitry to:
obtain an identifier that indicates a data item associated with an API infrastructure;
process the transactions of the API infrastructure logged by the distributed streaming platform to extract a named property from the transactions based on the identifier;
generate a data aggregation key based on the extracted named property;
aggregate the transactions based on the data aggregation key; and
provide aggregation data that characterizes the aggregated transactions to a security policy generation system.

9. The system of claim 8 further comprising a user interface circuitry configured to:
display a Graphical User Interface (GUI) that comprises selectable options to select one or more identifiers that indicate data items associated with the API infrastructure; and
receive a user input via the user interface that selects the identifier that indicates the data item associated with the API infrastructure; and
provide the identifier that indicates the data item associated with the API infrastructure to the processing circuitry.

10. The system of claim 8 wherein the processing circuitry is further configured to:
generate security policies based on the aggregation data to block unauthorized API requests to the API infrastructure; and
provide the security policies to the API infrastructure wherein the API infrastructure enforces the security policies to block the unauthorized API requests.

11. The system of claim 8 wherein the processing circuitry is further configured to:
generating security policies based on the aggregation data to block an API request originating from a bot to the API infrastructure; and
providing the security policies to the API infrastructure wherein the API infrastructure enforces the security policies to block the API request originating from the bot.

12. The system of claim 8 wherein the aggregation data comprises a count of unique values in the aggregated transactions.

13. The system of claim 8 wherein the aggregation data comprises a count of conditions in the aggregated transactions.

14. The system of claim 8 wherein the named property from the transactions comprises a named field located in the body or the header of the transactions.

15. One or more computer-readable storage media having program instructions stored thereon to aggregate transactions logged by a distributed streaming platform, wherein the program instructions, when executed by a computing system, direct the computing system to perform operations, the operations comprising:
obtaining an identifier that indicates a data item associated with an API infrastructure;
processing the transactions of the API infrastructure logged by the distributed streaming platform to extract a named property from the transactions based on the identifier;
generating a data aggregation key based on the extracted named property;
aggregating the transactions based on the data aggregation key; and
providing aggregation data that characterizes the aggregated transactions to a security policy generation system.

16. The computer-readable storage media of claim 15 wherein the operations further comprise:
displaying a user interface that comprises selectable options to select one or more identifiers that indicate data items associated with the API infrastructure; and wherein:
obtaining the identifier that indicates the data item associated with the API infrastructure comprises receiving a user input via the user interface that selects the identifier that indicates the data item associated with the API infrastructure.

17. The computer-readable storage media of claim 15 wherein the operations further comprise:
generating security policies based on the aggregation data to block unauthorized API requests to the API infrastructure; and
providing the security policies to the API infrastructure wherein the API infrastructure enforces the security policies to block the unauthorized API requests.

18. The computer-readable storage media of claim 15 wherein the operations further comprise:
generating security policies based on the aggregation data to block API request originating from bots to the API infrastructure; and
providing the security policies to the API infrastructure wherein the API infrastructure enforces the security policies to block the API request originating from bots.

19. The computer-readable storage media of claim 15 wherein the aggregation data comprises a first count of unique values in the aggregated transactions and a second count of conditions in the aggregated transactions.

20. The computer-readable storage media of claim 15 wherein the named property from the transactions comprises a named field located in the body or the header of the transactions.
